(19) United States
(12) Patent Application Publication
(10) Pub. No.: US 2019/0264013 A1
(43) Pub. Date: Aug. 29, 2019

(54) RUBBER COMPOSITION FOR TIRE AND PNEUMATIC TIRE USING SAME

(71) Applicant: TOYO TIRE CORPORATION, Itami-shi, Hyogo (JP)

(72) Inventor: Yasuhiro Hishikawa, Itami-shi (JP)

(73) Assignee: TOYO TIRE CORPORATION, Itami-shi, Hyogo (JP)

(21) Appl. No.: 16/348,318

(22) PCT Filed: Dec. 7, 2017
(86) PCT No.: PCT/JP2017/043964

§ 371 Date: May 8, 2019

(30) Foreign Application Priority Data
Dec. 15, 2016 (JP) 2016-243408

(51) Int. Cl. C08L 15/00; C08L 9/06; B60C 1/00

(52) U.S. Cl. CPC C08L 15/00; C08C 19/02; B60C 1/00; C08L 9/06

(57) ABSTRACT

A rubber composition for a tire having further improved processability while maintaining abrasion resistance that is a property of a hydrogenated copolymer, and a pneumatic tire using the same, are disclosed. A rubber composition for a tire comprising a solid rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and a liquid rubber.

### TECHNICAL FIELD

The present invention relates to a rubber composition for a tire and a pneumatic tire using the same.

### BACKGROUND ART

Pneumatic tire is required to have excellent abrasion resistance. As a method for improving abrasion resistance, Patent Documents 1 and 2 disclose using a hydrogenated copolymer having a hydrogenation ratio of a conjugated diene moiety of 75 mol % or more, obtained by copolymerizing aromatic vinyl and a conjugated diene compound.

However, a hydrogenated copolymer having high hydrogenation ratio has the problems that a viscosity is high and processability is poor. Patent Document 3 proposes a method for producing a hydrogenated copolymer having satisfactory processability, which comprises hydrogenating a conjugated diene polymer having a vinyl bond content of a conjugated diene moiety of 20 to 70% in which an alkoxysilyl group and a primary amino group that may be protected have been bonded to a polymer containing at least a conjugated diene unit such that a hydrogenation ratio of the conjugated diene moiety is 50% or more, thereby obtaining a hydrogenated diene polymer, and reacting at least one of a metal halide compound and an organic acidic compound with the hydrogenated diene polymer obtained. However, the improvement is still required in the method.

### PRIOR ART DOCUMENTS

### Patent Document

Patent Document 1: JP-A-2016-56349

Patent Document 2: JP-A-2016-56350

Patent Document 3: JP-A-2009-132907

Patent Document 4: JP-A-2003-253051

### SUMMARY OF THE INVENTION

### Problems that the Invention is to Solve

In view of the above, the present invention has an object to provide a rubber composition for a tire having further improved processability while maintaining abrasion resistance that is a property of a hydrogenated copolymer, and a pneumatic tire using the same.

A rubber composition disclosed in Patent Document 4 differs from the present invention in that a hydrogenated copolymer used has a weight average molecular weight of about 5,000 to 200,000 and the hydrogenated copolymer is mainly liquid. Furthermore, the hydrogenated copolymers used in the examples have a weight average molecular weight of about 10,000 and therefore have short molecular chain. Additionally, because of the hydrogenated copolymers, the number of the crosslinking points is small. Therefore, even though crosslinked, the copolymers are merely hung and bonded to a styrene-butadiene copolymer of component (A), and are not included in a network exhibiting rubber elasticity.

### Means for Solving the Problems

To solve the above-described problems, the rubber composition for a tire according to the present invention comprises a solid rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and a liquid rubber.

The content ratio of the hydrogenated copolymer in the solid rubber component is preferably 80 mass % or more.

The content of the liquid rubber is preferably 1 to 50 parts by mass per 100 parts by mass of the solid rubber component.

The liquid rubber can be at least one selected from the group consisting of isoprene rubber, butadiene rubber, styrene-butadiene rubber, isoprene-butadiene rubber, isoprene-styrene rubber, isoprene-butadiene rubber and hydrogenated products of those.

The pneumatic tire according to the present invention is manufactured using the rubber composition for a tire.

### Effects of the Invention

According to the rubber composition for a tire of the present invention, processability can be improved while maintaining abrasion resistance that is a property of the hydrogenated copolymer.

### MODE FOR CARRYING OUT THE INVENTION

The items relating to the embodiment of the present invention are described in detail below.

The rubber composition for a tire according to this embodiment comprises a solid rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and a liquid rubber. The solid rubber used herein means a solid rubber not having fluidity at room temperature (23° C.), and the liquid rubber means a liquid rubber having fluidity at room temperature (23° C.).

The solid rubber component used in the rubber composition according to this embodiment contains a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more. In the present description, the weight average molecular weight measured by gel permeation chromatography (GPC) is a value calculated in terms of polystyrene based on the commercially available standard polystyrene using a differential refractive index detector (RI) as a detector and using tetrahydrofuran (THF) as a solvent under the conditions that a measurement temperature is 40° C., a flow rate is 1.0 mL/min, a concentration is 1.0 g/L and an injection amount is 40 μL. The hydrogenation ratio is a value calculated from a spectrum decrease rate of an unsaturated bond moiety of a spectrum obtained by measuring H¹-NMR.

The aromatic vinyl constituting the aromatic vinyl-conjugated diene copolymer is not particularly limited, but examples thereof include styrene, α-methylstyrene, 1-vinylnaphthalene, 3-vinyltoluene, ethylvinylbenzene, divinylbenzene, 4-cyclohexylstyrene and 2,4,6-trimethylstyrene. Those may be used alone or as a combination of two or more kinds.

The conjugated diene constituting the aromatic vinyl-conjugated diene copolymer is not particularly limited, but examples thereof include 1,3-butadiene, isoprene, 1,3-pentadiene, 2,3-dimethylbutadiene, 2-pheny-1,3-butadiene and 1,3-hexadiene. Those may be used alone or as a combination of two or more kinds.

The aromatic vinyl-conjugated diene copolymer is not particularly limited, but a copolymer of styrene and 1,3-butadiene (styrene-butadiene copolymer) is preferred. Therefore, the hydrogenated copolymer is preferably a hydrogenated styrene-butadiene copolymer. The hydrogenated copolymer may be a random copolymer, may be a block copolymer and may be an alternating copolymer. The aromatic vinyl-conjugated diene copolymer may be modified with at least one functional group selected from the group consisting of amino group, hydroxyl group, epoxy group, alkoxy group, alkylsilyl group, alkoxysilyl group and carboxyl group at a molecular end or in a molecular chain.

The hydrogenated copolymer can be synthesized by, for example, synthesizing an aromatic vinyl-conjugated diene copolymer and conducting a hydrogenation treatment. A method for synthesizing the aromatic vinyl-conjugated diene copolymer is not particularly limited, but the examples thereof include a solution polymerization method, a gas phase polymerization method and a bulk polymerization method, and a solution polymerization method is preferred. The polymerization form may be any of a batch type and a continuous type. The aromatic vinyl-conjugated diene copolymer can use the commercially available copolymers.

The hydrogenation method is not particularly limited, and the aromatic vinyl-conjugated diene copolymer is hydrogenated by the conventional method under the conventional conditions. The hydrogenation is generally conducted at 20 to 150° C. under a hydrogen pressure of 0.1 to 10 MPa in the presence of a hydrogenation catalyst. The hydrogenation ratio can be optionally adjusted by changing the amount of a hydrogenation catalyst, a hydrogen pressure when hydrogenating, a reaction time and the like. The hydrogenation catalyst can generally use a compound containing any of metals of Groups 4 to 11 of the periodic table. For example, a compound containing Ti, V, Co, Ni, Zr, Ru, Rh, Pd, Hf, Re or Pt atom can be used as the hydrogenation catalyst. Examples of more specific hydrogenation catalysts include a metallocene compound such as Ti, Zr, Hf, Co, Ni, Pd, Pt, Ru, Rh or Re; a supported type heterogeneous catalyst comprising a carrier such as carbon, silica, alumina or diatomaceous earth and a metal such as Pd, Ni, Pt, Rh or Ru supported thereon; a homogeneous Ziegler catalyst comprising a combination of an organic salt or acetylacetone salt of a metal element such as Ni or Co and a reducing agent such as organic aluminum; an organic metal compound or complex of Ru or Rh; and fullerene or carbon nanotube having hydrogen occluded therein.

The hydrogenation ratio of the hydrogenated copolymer (proportion of hydrogenated moiety in conjugated diene moiety of aromatic vinyl-conjugated diene copolymer) is 80 mol % or more and preferably 90 mol % or more. When the hydrogenation ratio is 80 mol % or more, the improvement effect of strength and abrasion resistance due to homogenization of crosslinking is excellent.

The weight average molecular weight of the hydrogenated copolymer is not particularly limited so long as it is 300,000 or more. The weight average molecular weight is preferably 300,000 to 2,000,000, more preferably 300,000 to 1,000,000 and still more preferably 300,000 to 600,000.

The solid rubber component may contain a diene rubber other than the hydrogenated copolymer, and examples of the diene rubber include natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber. Those diene rubbers can be used in one kind alone or as a blend of two or more kinds.

The content ratio of the hydrogenated copolymer in the solid rubber component is not particularly limited, but, is preferably 80 to 100 mass % and more preferably 90 to 100 mass %. When the content ratio is 80 mass % or more, the improvement effect of abrasion resistance is excellent.

The rubber composition of this embodiment contains a liquid rubber that is liquid at room temperature (23° C.).

The liquid rubber is not particularly limited, but is preferably a liquid diene rubber, and examples thereof include isoprene rubber, butadiene rubber, styrene-butadiene rubber, isoprene-butadiene rubber, isoprene-styrene rubber, isoprene-butadiene-styrene rubber, isobutylene and ethylene-propylene-diene rubber (EPDM). Those liquid rubbers may be rubbers modified by carboxylation, methacrylation or the like and may be rubbers hydrogenated. Furthermore, when the liquid rubber is a copolymer, the copolymer may be an alternating copolymer, may be a block copolymer and may be a random copolymer. Those liquid rubbers can be used in one kind alone or as blends of two or more kinds.

The liquid rubber can use commercially available liquid rubbers. Examples of the isoprene rubber include LIR-30, LIR-50, LIR-310, LIR-390, LIR-410, UC-203, UC-102, LIR-290 and LIR-700, manufactured by Kuraray Co., Ltd. Examples of the butadiene rubber include LBR-307, LBR-305 and LBR-352, manufactured by Kuraray Co., Ltd. Examples of the styrene-butadiene rubber include L-SBR-820 and L-SBR-841, manufactured by Kuraray Co., Ltd.

The weight average molecular weight of the liquid rubber is not particularly limited, but, is preferably 1,000 to 100,000 and more preferably 2,000 to 50,000.

The content of the liquid rubber (total amount when using two or more kinds) is not particularly limited, but is preferably 1 to 50 parts by mass, more preferably 5 to 30 parts by mass and still more preferably 5 to 20 parts by mass, per 100 parts by mass of the solid rubber component.

In the rubber composition according to this embodiment, carbon black and/or silica can be used as the reinforcing filler. In other words, the reinforcing filler may be carbon black alone, may be silica alone and may be a combination of carbon black and silica. A combination of carbon black and silica is preferably used. The content of the reinforcing filler is not particularly limited, and is, for example, preferably 10 to 150 parts by mass, more preferably 20 to 100 parts by mass and still more preferably 30 to 80 parts by mass, per 100 parts by mass of the solid rubber component.

The carbon black is not particularly limited and conventional various kinds can be used. The content of the carbon black is preferably 1 to 70 parts by mass and more preferably 1 to 60 parts by mass, per 100 parts by mass of the solid rubber component.

The silica is not particularly limited, but wet silica such as wet precipitated silica or wet gelled silica is preferably used. When the silica is contained, its content is preferably 10 to 120 parts by mass and more preferably 15 to 100 parts by mass, per 100 parts by mass of the solid rubber component from the standpoints of balance of tan 8 of rubber, reinforcing properties and the like.

When the silica is contained, a silane coupling agent such as sulfide silane or mercaptosilane may be further contained. When the silane coupling agent is contained, its content is preferably 2 to 20 mass % based on the silica content.

In addition to the above components, compounding ingredients used in general rubber industries, such as a process oil, zinc flower, stearic acid, a softener, a plasticizer, a wax, an age resister, a vulcanizing agent and a vulcanization accelerator can be appropriately added in the general range to the rubber composition according to this embodiment.

Examples of the vulcanizing agent include sulfur components such as powdered sulfur, precipitated sulfur, colloidal sulfur, insoluble sulfur and highly dispersible sulfur. Although not particularly limited, the content of the vulcanizing agent is preferably 0.1 to 10 parts by mass and more preferably 0.5 to 5 parts by mass, per 100 parts by mass of the solid rubber component. The content of the vulcanization accelerator is preferably 0.1 to 7 parts by mass and more preferably 0.5 to 5 parts by mass, per 100 parts by mass of the solid rubber component.

The rubber composition according to this embodiment can be produced by kneading the necessary components according to the conventional method using a mixing machine generally used, such as Banbury mixer, a kneader or rolls. Specifically, additives excluding a vulcanizing agent and a vulcanization accelerator are added to the solid rubber component together with the liquid rubber, followed by mixing, in a first mixing step, and a vulcanizing agent and a vulcanization accelerator are added to the mixture obtained, followed by mixing, in a final mixing step. Thus, a rubber composition can be prepared.

The rubber composition thus obtained can be used for a tire and can be applied to each site of a tire, such as a tread part or a sidewall part of pneumatic tires having various uses or sizes, such as tires for passenger cars or large-size tires for trucks or buses. The rubber composition is molded into a predetermined shape by, for example, extrusion processing according to the conventional method, combined with other parts and then vulcanized at, for example, 140 to 180° C. Thus, a pneumatic tire can be manufactured.

The kind of the pneumatic tire according to this embodiment is not particularly limited, and examples of the pneumatic tire include various tires such as tires for passenger cars and heavy load tires for trucks, buses and the like.

### EXAMPLES

Examples of the present invention are described below, but the present invention is not construed as being limited to those examples.

### Synthesis Example 1 of Hydrogenated Copolymer

2.5 L of cyclohexane, 50 g of tetrahydrofuran, 0.12 g of n-butyl lithium, 100 g of styrene and 400 g of 1,3-butadiene were put in a nitrogen-substituted heat-resistant reactor, and polymerization was conducted at a reaction temperature of 50° C. After completion of the polymerization, 1.7 g of N,N-bis(trimethylsilyl)aminopropylmethyl diethoxysilane was added, a reaction was conducted for 1 hour and hydrogen gas was then supplied under a pressure of 0.4 MPa-gauge. The reaction was conducted at a reaction temperature of 90° C. under a hydrogen gas supply pressure of 0.7 MPa-gauge using a catalyst mainly comprising titanocene dichloride until reaching a target hydrogenation ratio. Solvent was removed to obtain hydrogenated copolymer 1.

The hydrogenated copolymer obtained had a weight average molecular weight by GPC of 350,000 in terms of polystyrene by standard polystyrene. The measurement was conducted using “LC-10A” manufactured by Shimadzu Corporation as a measuring instrument using “PLgel-MIXED-C” manufactured by Polymer Laboratories as a column, using a differential refractive index detector (RI) as a detector and using THF as a solvent under the conditions that a measurement temperature is 40° C., a flow rate is 1.0 mL/min, a concentration is 1.0 g/L and an injection amount is 40 μL. The amount of bonded styrene was 20 mass % and the hydrogenation ratio of the butadiene moiety was 90 mol %. The amount of styrene bonded was obtained from a spectrum intensity ratio of proton based on styrene unit and proton based on butadiene unit (containing hydrogenated moiety) using H¹-NMR.

### Synthesis Example 2 of Hydrogenated Copolymer

Hydrogenated copolymer 2 was obtained by the same method as Synthesis Example 1, except for changing the reaction time for hydrogenation and changing the target hydrogenation ratio. The hydrogenated copolymer 2 obtained had a weight average molecular weight of 350,000 in terms of polystyrene by standard polystyrene. The amount of bonded styrene was 20 mass % and the hydrogenation ratio of the butadiene moiety was 80 mol %.

### EXAMPLES AND COMPARATIVE EXAMPLES

Using a Banbury mixer, components excluding a vulcanization accelerator and sulfur were added according to the formulations (parts by mass) shown in Table 1 below, followed by mixing, in a first mixing step (non-processing kneading step) (discharge temperature: 160° C.). A vulcanization accelerator and sulfur were added to the mixture obtained, followed by mixing, in a final mixing step (processing kneading step) (discharge temperature: 90° C.). Thus, a rubber composition was prepared.

The details of each component in Table 1 are as follows.

SBR: “HPR350” manufactured by JSR Corporation

Hydrogenated SBR 1: Hydrogenated copolymer 1 prepared according to Synthesis Example 1

Hydrogenated SBR 2: Hydrogenated copolymer 2 prepared according to Synthesis Example 2

Silica: “Ultrasil VN3” manufactured by Evonik

Carbon black: “SEAST 3” manufactured by Tokai Carbon Co., Ltd.

Oil: “PROCESS NC140” manufactured by JX Nippon Oil & Sun Energy Corporation

Liquid rubber 1: “LIR290” manufactured by Kuraray Co, Ltd., hydrogenated liquid isoprene rubber, weight average molecular weight: 31000

Liquid rubber 2: “LIR30” manufactured by Kuraray Co, Ltd., liquid isoprene rubber, weight average molecular weight: 28000

Liquid rubber 3: “LBR307” manufactured by Kuraray Co, Ltd., liquid butadiene rubber, weight average molecular weight: 8000

Liquid rubber 4: “Ricon 184” manufactured by Cray Valley, butadiene-styrene random copolymer, weight average molecular weight: 8600

Zinc flower: “Zinc Flower #3” manufactured by Mitsui Mining & Smelting Co., Ltd.

Stearic acid: “LUNAC S-20” manufactured by Kao Corporation

Age resister: “NOCRAC 6C” manufactured by Ouchi Shinko Chemical Industrial Co., Ltd.

Wax: “OZOACE 0355” manufactured by Nippon Seiro Co., Ltd.

Silane coupling agent: “Si60” manufactured by Evonik

Sulfur: “Powdered Sulfur” manufactured by Tsurumi Chemical Industry Co., Ltd.

Vulcanization accelerator 1: Guanidine type accelerator, “NOCCELER D” manufactured by Ouchi Shinko Chemical Industrial Co., Ltd.

Vulcanization accelerator 2: Sulfenamide type accelerator, “SOXINOL CZ” manufactured by Sumitomo Chemical Co., Ltd.

Vulcanization accelerator 3: Thiuram type accelerator, “ACCEL TBZT” manufactured by Kawaguchi Chemical Industry Co., Ltd.

Processability and abrasion resistance of each composition obtained were evaluated. The evaluation methods are as follows.

Processability: An unvulcanized rubber was preheated at 100° C. for 1 minute and then a torque value after 4 minutes was measured in Mooney unit using a rotorless Mooney measuring instrument manufactured by Toyo Seiki Seisaku-Sho according to MS K6300. The processability was indicated by an index as the value of Comparative Example 1 being 100. Smaller index shows low viscosity and excellent processability.

Abrasion resistance: Measured using a test piece having a predetermined shape obtained by vulcanizing the rubber composition obtained at 160° C. for 30 minutes according to JIS K6264. Specifically, abrasion quantity was measured under the conditions of load: 29.4N, slip ratio: 20%, temperature: 23° C. and sand falling amount: 20 g/min using Lambourn abrasion tester. The reverse number of the abrasion amount is indicated by an index as the value of Comparative Example 1 being 100. Larger value shows excellent abrasion resistance.

TABLE 1

| | Com. Ex. 1 | Com. Ex. 2 | Com. Ex. 3 | Ex. 1 | Ex. 2 | Ex. 3 | Ex. 4 | Ex. 5 | Ex. 6 | Ex. 7 | Ex. 8 |
|---|---|---|---|---|---|---|---|---|---|---|---|
| SBR | 100 | 100 | — | — | — | — | — | — | 30 | 20 | — |
| Hydrogenated SBR 1 | — | — | 100 | 100 | 100 | 100 | 100 | 100 | 70 | 80 | — |
| Hydrogenated SBR 2 | — | — | — | — | — | — | — | — | — | — | 100 |
| Silica | 70 | 70 | 70 | 70 | 70 | 70 | 70 | 70 | 70 | 70 | 70 |
| Carbon Black | 5 | 5 | 5 | 5 | 5 | 5 | 5 | 5 | 5 | 5 | 5 |
| Oil | 20 | 10 | 20 | 10 | 10 | 10 | 10 | — | 10 | 10 | 10 |
| Liquid rubber 1 | — | — | — | 10 | — | — | — | — | — | — | — |
| Liquid rubber 2 | — | — | — | — | 10 | — | — | — | — | — | — |
| Liquid rubber 3 | — | 10 | — | — | — | 10 | — | 20 | 10 | 10 | 10 |
| Liquid rubber 4 | — | — | — | — | — | — | 10 | — | — | — | — |
| Zinc flower | 3 | 3 | 3 | 3 | 3 | 3 | 3 | 3 | 3 | 3 | 3 |
| Stearic acid | 2 | 2 | 2 | 2 | 2 | 2 | 2 | 2 | 2 | 2 | 2 |
| Age resister | 2 | 2 | 2 | 2 | 2 | 2 | 2 | 2 | 2 | 2 | 2 |
| Wax | 2 | 2 | 2 | 2 | 2 | 2 | 2 | 2 | 2 | 2 | 2 |
| Silane coupling agent | 5 | 5 | 5 | 5 | 5 | 5 | 5 | 5 | 5 | 5 | 5 |
| Sulfur | 2 | 2 | 2 | 2 | 2 | 2 | 2 | 3 | 2 | 2 | 2 |
| Vulcanization | 1.5 | 1.5 | 1.5 | 1.5 | 1.5 | 1.5 | 1.5 | 2 | 1.5 | 1.5 | 1.5 |
| accelerator 1 | | | | | | | | | | | |
| Vulcanization | 1.5 | 1.5 | 1.5 | 1.5 | 1.5 | 1.5 | 1.5 | 2 | 1.5 | 1.5 | 1.5 |
| accelerator 2 | | | | | | | | | | | |
| Vulcanization | 1 | 1 | 1 | 1 | 1 | 1 | 1 | 1 | 1 | 1 | 1 |
| accelerator 3 | | | | | | | | | | | |
| Processability | 100 | 105 | 150 | 135 | 140 | 130 | 135 | 120 | 110 | 107 | 120 |
| Abrasion resistance | 100 | 100 | 130 | 125 | 130 | 140 | 138 | 150 | 110 | 108 | 133 |

The results are shown in Table 1. It is understood from the comparison between Comparative Example 1 and Comparative Example 3 that when the hydrogenated SBR is used, processability is greatly deteriorated.

It was recognized from the comparison between Comparative Example 3 and Examples 1 to 5 and 8 that when the hydrogenated SBR and the liquid rubber are used in combination, processability is improved while maintaining or further improving abrasion resistance that is a property of a hydrogenated copolymer-containing tire.

It is understood from the comparison between Comparative Example 1 and Comparative Example 2 that when the liquid rubber is used in combination with SBR, processability is rather deteriorated.

### INDUSTRIAL APPLICABILITY

The rubber composition for a tire of the present invention can be used in various tires of passenger cars, light trucks, buses and the like.

1. A rubber composition for a tire comprising:
a solid rubber component containing a hydrogenated copolymer obtained by hydrogenating an aromatic vinyl-conjugated diene copolymer, the hydrogenated copolymer having a weight average molecular weight measured by gel permeation chromatography of 300,000 or more and having a hydrogenation ratio of a conjugated diene moiety of 80 mol % or more, and
a liquid rubber.

2. The rubber composition for a tire according to claim 1, wherein the content ratio of the hydrogenated copolymer in the solid rubber component is 80 mass % or more.

3. The rubber composition for a tire according to claim 1, wherein the content of the liquid rubber is 1 to 50 parts by mass per 100 parts by mass of the solid rubber component.

4. (canceled)

5. The rubber composition for a tire according to claim 1, wherein the liquid rubber is at least one selected from the group consisting of isoprene rubber, butadiene rubber, styrene-butadiene rubber, isoprene-butadiene rubber, isoprene-styrene rubber, isoprene-butadiene-styrene rubber and hydrogenated products of those.

6. The rubber composition for a tire according to claim 2, wherein the content of the liquid rubber is 1 to 50 parts by mass per 100 parts by mass of the solid rubber component.

7. The rubber composition for a tire according to claim 2, wherein the liquid rubber is at least one selected from the group consisting of isoprene rubber, butadiene rubber, styrene-butadiene rubber, isoprene-butadiene rubber, isoprene-styrene rubber, isoprene-butadiene-styrene rubber and hydrogenated products of those.

8. The rubber composition for a tire according to claim 3, wherein the liquid rubber is at least one selected from the group consisting of isoprene rubber, butadiene rubber, styrene-butadiene rubber, isoprene-butadiene rubber, isoprene-styrene rubber, isoprene-butadiene-styrene rubber and hydrogenated products of those.

9. The rubber composition for a tire according to claim 6, wherein the liquid rubber is at least one selected from the group consisting of isoprene rubber, butadiene rubber, styrene-butadiene rubber, isoprene-butadiene rubber, isoprene-styrene rubber, isoprene-butadiene-styrene rubber and hydrogenated products of those.

10. A pneumatic tire manufactured using the rubber composition for a tire according to claim 1.

11. A pneumatic tire manufactured using the rubber composition for a tire according to claim 2.

12. A pneumatic tire manufactured using the rubber composition for a tire according to claim 3.

13. A pneumatic tire manufactured using the rubber composition for a tire according to claim 5.

14. A pneumatic tire manufactured using the rubber composition for a tire according to claim 6.

15. A pneumatic tire manufactured using the rubber composition for a tire according to claim 7.

16. A pneumatic tire manufactured using the rubber composition for a tire according to claim 8.

17. A pneumatic tire manufactured using the rubber composition for a tire according to claim 9.
